(19) United States
(12) Patent Application Publication
(10) Pub. No.: US 2024/0150963 A1
(43) Pub. Date: May 9, 2024

(54) ROLL ARRANGEMENT

(71) Applicant: Voith Patent GmbH, Heidenheim (DE)

(72) Inventors: José Luiz Campos Souza, Heidenheim (DE); Dominik Marusa, Ulm (DE); Thomas Martin, Langenau (DE)

(73) Assignee: Voith Patent GmbH, Heidenheim (DE)

(21) Appl. No.: 18/412,110

(22) Filed: Jan. 12, 2024

Related U.S. Application Data
(63) Continuation of application No. PCT/EP22/65998, filed on Jun. 13, 2022.

(30) Foreign Application Priority Data
Jul. 14, 2021 (DE) 10 2021 118 165.8

(51) Int. Cl. D21F 3/08; B31F 1/12; D21F 3/04; D21F 7/08

(52) U.S. Cl. CPC D21F 3/08; B31F 1/128; D21F 3/04; D21F 7/08

(57) ABSTRACT

A roll arrangement for producing a web of fibrous material which is compressed includes: a compression press, which includes at least one compression roll and a mating roll and is configured for compressing the web in a transverse direction which is transverse to a conveying direction of the web; and a tensioning belt, which is elastic and is configured for supporting the web and for being guided through a first nip between the at least one compression roll and the mating roll and over the at least one compression roll.

### CROSS REFERENCE TO RELATED APPLICATIONS

This is a continuation of PCT application no. PCT/EP2022/065998, entitled “ROLL ARRANGEMENT”, filed Jun. 13, 2022, which is incorporated herein by reference. PCT application no. PCT/EP2022/065998 claims priority to German patent application no. 10 2021 118 165.8, filed Jul. 14, 2021, which is incorporated herein by reference.

### BACKGROUND OF THE INVENTION

### 1. Field of the Invention

The present invention relates to a roll arrangement, and, more particularly, to a roll arrangement for producing a compressed fibrous web using a compression press.

### 2. Description of the Related Art

A roll arrangement of this type is used in a paper machine to create a controlled transverse shrinkage in a plane formed by the fibrous web in a direction transverse to the conveying direction of the fibrous web using the compression press. Control over the transverse shrinkage of the fibrous web is particularly desirable since in hitherto known processes, a desired longitudinal shrinkage of the fibrous web or a change in length in the conveying direction of the fibrous web can be specifically influenced by suitable measures or processes (for example Clupak process). However, the transverse shrinkage or change in width of the fibrous web is invariably a rather random consequence of the subsequent drying process, which is hardly ever, or not at all, controllable. With the currently known processes, longitudinal shrinkage of 15 to 17% is possible at a dry content of 60 to 70%, wherein these processes are mostly applicable to fibrous webs having a basis weight of 60 to 70 g/m² or slightly higher.

For transverse shrinkage of the fibrous web in the compression press, axial forces directed inwards in opposite directions act in a nip formed by a compression roll and a mating roll, in the direction parallel to the longitudinal axes of the compression roll and mating roll, which are transferred to the fibrous web in order to compress the fibrous web in the plane of the fibrous web transverse to the conveying direction thereof. The longitudinal axes of the compression roll and the mating roll as well as the longitudinal extension of the nip are thereby aligned parallel to the plane of the fibrous web and transverse to the conveying direction of the fibrous web.

During transverse shrinkage of the fibrous web, the fibrous web is compressed in its width, in other words transversely to its longitudinal extension extending in the direction of conveyance in the fibrous web plane, but optionally without creping the fibrous web. At the same time, the compressed fibrous web remains stretchable in the direction of its width.

Stretchable fibrous materials, in particular fibrous materials that can be stretched both longitudinally and transversely, such as stretchable papers or cardboard, are used, for example, as raw materials for the manufacture of molded objects, such as plates produced by a pressing and/or thermoforming or similar process. Moreover, stretchable fibrous materials are used in fiber packaging where elastic properties are desired, such as sack paper for the use of sacks. For such products, papers or cartons which are made of a stretchable fibrous web with the highest possible elongation at break are of great importance.

While the processes known to date already offer suitable solutions for the production of a fibrous web having satisfactory longitudinal stretchability and the highest possible elongation at break, the production of a fibrous web having sufficient width stretchability, especially in combination with the highest possible elongation at break in the transverse direction, still represents a major challenge.

What is needed in the art is to improve roll arrangements. In particular, what is needed in the art is a roll arrangement that enables the production of a fibrous web that can be stretched both in the direction of conveyance as well as transversely thereto, in the plane of the fibrous web. In particular, what is needed in the art is a roll arrangement that enables uniform compression in the plane of the fibrous web, as well as in the direction of conveyance and transversely thereto.

### SUMMARY OF THE INVENTION

The present invention relates to a roll arrangement for producing a compressed fibrous web using a compression press. The compression press includes at least one compression roll and one mating roll and is designed to compress the fibrous web in a direction transverse to the conveying direction of the fibrous web. The present invention provides a roll arrangement and in particular an elastic tensioning belt that supports the fibrous web, which is guided through a nip between the compression roll and the mating roll and over the compression roll. The conveying directions of the fibrous web and the tensioning belt are aligned. Thus, the present invention provides a roll arrangement for producing a comprossed fibrous web by use of a compression press which includes at least one compression roll and one mating roll and which is designed to compress the fibrous web in a direction transverse to a conveying direction of the fibrous web, wherein an elastic tensioning belt which supports the fibrous web is provided and which is guided through a nip between the compression roll and the mating roll and over the compression roll.

The present invention is based on the general idea of evenly supporting a fibrous web during its transport through the nip between the compression roll and the mating roll (compression nip) by way of a tensioning belt. Due to the support, a part of the web tension generated by the roll arrangement or by the paper machine is transferred to the tensioning belt, so that the extent of the web tension acting on the fibrous web is reduced. The advantage of reducing the web tension acting on the fibrous web is that the elongation at break of the fibrous web can be increased, so that the fibrous web has a higher stretchability as a result.

In addition, by guiding the tensioning belt over the compression roll, the tensioning belt separates the fibrous web that is to be conveyed from the compression roll, so that the fibrous web does not come into direct contact with the compression roll. The additional support provided for the fibrous web has the advantage that in particular the lateral forces occurring in the compression nip, which are generated by the compression roll, do not act directly on the fibrous web, but act indirectly on the fibrous web via the tensioning belt. As a result, the forces acting in the compression nip are gently transferred to the fibrous web by way of the tensioning belt, so that an undesirable puckering in the fibrous web or—in the worst case—damage to the fibrous web can be avoided.

A further advantage of the present invention is that the roll arrangement can be used with heavier fibrous webs than was the case hitherto. For example, it has been shown that with a roller arrangement according to the invention, a controlled transverse shrinkage of 10 to 30% relative to an initial width of the fibrous web before the roller arrangement is possible with fibrous webs which have a basis weight of 70 to 200 g/m² and a dry content of 55 to 90%.

Optional dry contents of the fibrous web with which the roll arrangement may be used can be between 55 and 58%, between 60 and 65% or between 66 and 70%.

So that the tensioning belt can optionally only be stretched in one plane of the tensioning belt, transversely to the direction of conveyance, it is advantageous if the tensioning belt is more elastic in the tensioning belt plane in the direction transverse to the direction of conveyance, in other words has a lower modulus of elasticity than in the conveying direction. For this purpose, the tensioning belt can have at least one reinforcing way extending in the direction of conveyance, which has a lower elasticity, that is, a higher modulus of elasticity, than the tensioning belt. The reinforcing way is used in particular to prevent undesirable distortions of the embodiment of a reinforcing belt. For example, the reinforcing belt can be flat or have a round cross-section.

Sufficient support of the fibrous web with simultaneous good elasticity of the tensioning belt can be achieved for tensioning belt widths of less than or equal to 1 m if the tensioning belt has a hardness of 20 to 65 Shore A (shore hardness), optionally 25 to 60 Shore A and especially optionally 30 to 55 Shore A. For tensioning belts having a width greater than or equal to 1 m, a hardness of 30 to 65 Shore A, optionally 35 to 60 Shorea A, and optionally 40 to 55 ShA has proven to be advantageous.

In order to increase the adhesion between the tensioning belt and the fibrous web and/or to influence or shape the surface of the fibrous web, the tensioning belt may be structured. Optionally, the structuring is provided on a side facing the fibrous web that is to be conveyed.

To stretch the tensioning belt in the tensioning belt plane in the direction transverse to the conveying direction, at least one, in particular two, optionally three, optionally four, spreader rollers can be provided, by way of which the tensioning belt can be prestressed in the direction transverse to the conveying direction of the tensioning belt against a restoring force of the tensioning belt before the fibrous web is received. In other words, the spreader roll is used to pre-stretch the tensioning belt in the tensioning belt plane in the direction transverse to the conveying direction before the fibrous web is picked up, by expanding the width of the tensioning belt in the tensioning belt plane in the direction transverse to the conveying direction. Optionally, a pre-stretching of the tensioning belt of 10 to 15% with respect to its relaxed initial width can be achieved with only one spreader roller. Such pre-stretching can be achieved, for example, with a cambered spreader roller.

In an alternative embodiment of the present invention, it is conceivable that in place of the spreader roll another spreader element such as a spreader brush or a spreader bar is used. Optionally, two, three or four spreader elements can also be provided.

Advantageously, a spreader brush is a very simple design and at the same time has a positive effect on the surface of the tensioning belt. Advantageously, a spreader bar is a very cost-effective design variant of a spreader element.

For even stronger pre-stretching of the tensioning belt, several spreader rolls, for example, two, three or four spreader rolls can be arranged one behind the other to form a so-called spreader arrangement.

It is advantageous to have several, in particular two, especially three, or especially four, spreader elements, for example a spreader brush or a spreader bar, to form a spreader arrangement.

Optionally, a feed roll is provided, which, together with the mating roll, forms a nip (feed nip) which, viewed in circumferential direction of the mating roll, is located upstream—in direction of conveyance—of the nip (compression nip) which is formed by the compression roll and the mating roll. According to an optional design of the roll arrangement, the feed nip is positioned at least 15°—as viewed in the circumferential direction of the mating roll—in front of the compression nip—as seen in the conveying direction. According to one embodiment, the tensioning belt and the fibrous web come into contact with each other here. The line load in the feed nip can be adjusted as required to achieve the desired adhesion between the tensioning belt and the fibrous web.

Analogous to the situation in the compression nip, the distance between the feed roll and the mating roll narrows to the middle of the feed nip, where the distance between the feed roll and the mating roll reaches a minimum. Due to the narrowing between the rolls, the Venturi effect occurs, so that the tensioning belt and ultimately also the fibrous web conveyed by the tensioning belt are initially accelerated as a result of the narrowing and subsequently decelerated due to the expansion after the center of the feed nip. As a result, the fibrous web is compressed in the conveying direction. Such compression in the conveying direction leads to an increase in the elongation at break in the conveying direction of 6 to 8%.

In other words, the nip between the feed roll and the mating roll also allows the use of the Venturi effect to achieve additional compression of the fibrous web in the direction of conveyance.

To ensure that the acceleration of the tensioning belt or the fibrous web that is to be conveyed in the narrowing of the nip is not too great, it is advantageous if the tensioning belt has a thickness between 2 and 30 mm, optionally between 4 and 26 mm.

Optionally, the thickness of the tensioning belt for tensioning belts having a width of less than or equal to 1 m is between 4 and 6 mm, whereas for tensioning belts having widths greater than or equal to 1 m, the thickness of the tensioning belt may be between 4 and 26 mm.

The forward displacement of the contact between the fibrous web and the tensioning belt by way of the feed roller allows the tensioning belt and the fibrous web to be conveyed along the mating roller for a certain period of time before the tensioning belt and the fibrous web reach the compression nip.

If one, two, three or four spreader rolls or such a roll arrangement is provided, the feed roll may be located between the spreader roll (or the roll arrangement) and the mating roll so that the pre-strech of the tensioning belt is substantially maintained. A particularly low loss of pre-strech can be achieved by placing the feed roll immediately or a short distance after the—optionally last—spreader roll. In this context, “immediate” means that a pre-stretch of the tensioning belt created by the spreader roll does not decrease or does not decrease appreciably on reaching the feed roll.

To separate the fibrous web and the tensioning belt after the compression nip, a deflection roll can be provided, which—viewed in conveying direction of the tensioning belt—is located downstream of the compression press in the conveying direction and which guides the tensioning belt away from the fibrous web that is to be conveyed.

According to an advantageous arrangement, the deflection roller is arranged in such a way that the tensioning belt is guided over an angular section of the mating roll. At high speeds (for example >600 m/min) of the fibrous web, it can be advantageous to increase the contact time between the tensioning belt and the fibrous web, as this also leads to an increase in compression.

However, it is also possible that the deflection roller is arranged in such a way that the tensioning belt is not guided over the mating roll, but optionally over an angular section of the compression roll. In this way, the fibrous web can leave the tensioning belt directly or comparatively shortly after the compression nip, which is particularly advantageous at comparatively low conveying speeds (for example <25 m/min).

The deflection roll can be designed to be relocatable, so that guidance of the fibrous web along a section of the circumference of the compression roll and/or the mating roll can be selectively changed. By changing the position of the deflection roll, it is possible for example to make adjustments to the size of the angle range in which the tensioning belt is in contact with the corresponding roller.

For adjustment of a suitable pretension of the tensioning belt in conveying direction, a repositionable tension roll is optionally provided.

In order to facilitate sliding of the fibrous web on the mating roll, the mating roll may have a smooth shell surface or one that is provided with openings. Alternatively or additionally, the mating roll can also have a porous shell surface. If the mating roll has a shell surface that is provided with openings or one that is porous, compressed air or water vapor can be passed or in particular pressed through the openings of the porous shell surface, which facilitates sliding of the fibrous web along the mating roll. A non-stick coating can be provided—additionally or alternatively. This also applies, among other things, to the feed and/or deflection roller(s).

According to an optional design, the compression roll has a rotationally symmetrical base body that can be rotated around a longitudinal axis with a shell surface on which at least two elastically deformable and/or deflectable ring-shaped lamellae are arranged, which extend in a radial direction away from the shell surface and which surround the base body in the circumferential direction.

For particularly uniform compression of the fibrous web in the direction transverse to the conveying direction in the fibrous web plane, the lamallea can be inclined mirror-symmetrically in pairs in the direction of the center plane of the compression roll, forming an angle of inclination, slanting to a center plane of the compression roll aligned perpendicular relative to the longitudinal axis of the compression roll. The lamellae can be designed to be on a roll cover which is pulled over the base body of the compression roll. Other designs of the compression roll or the corresponding roll cover are possible.

The distance between the compression roll and the mating roll is optionally adjustable. By varying the distance between compression roll and mating roll, pressure of varying strength can be exerted in the compression nip onto the lamellae of the commpession roll. The stronger the pressure acting on the lamellae in the nip, in other words the smaller the distance between the longitudinal axes of the compression roll and the counter roll, the greater the deflection of the lamellae. A stronger deflection of the lamellae in the nip in the direction of the center plane is consistent with a stronger compression of the fibrous web in the fibrous web plane in the direction transverse to the conveying direction.

In addition, the deflection of the lamellae also depends on their angle of inclination and the material properties of the lamella material. The stronger the inclination of the lamellae, the easier it is to deflect the lamellae towards the centre plane. In addition, easier deflection of the lamellae is achieved with softer materials.

For particularly efficient compression of the fibrous web in the fibrous material plane in the direction transverse to the conveying direction, it is advantageous that several compression rolls are assigned to the mating roll, each of which form a compression nip together with the mating roll.

The present invention is also focused on a method for producing a compressed fibrous web, in particular by using a roll arrangement as described above. It includes at least the following steps:
merging a fibrous web with a tensioning belt, which receives the fibrous web to convey the fibrous web in one conveying direction;
conveying the tensioning belt together with the fibrous web to a compression press which includes at least one compression roll and one mating roll and which is designed to produce compression of the fibrous material web in one direction transverse to the conveying direction in a fibrous web plane; and
Guidance of the tensioning belt together with the fibrous web through a nip formed between the compression roll and the mating roll, and over the compression roll in order to compress the fibrous web transversely to the conveying direction in the fibrous web plane.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic view of a roll arrangement with a spreader roll;

FIG. 2 is one detail of the schematic view of the roll arrangement of FIG. 1 with several, optionally three, spreader rolls;

FIG. 3 is compression roll of the roll arrangement of FIG. 1;

FIG. 4A is a top view of a section of a tensioning belt of a roll assembly from FIG. 1;

FIG. 4B is a perspective view of a section of the tensioing belt from FIG. 4A;

FIG. 5A is one detail of the roll arrangement of FIG. 1 with a deflection roll in a first position;

FIG. 5B is the deflection roll of FIG. 5A in a second position;

FIG. 6 is a schematic detailed view of a further development of the roll arrangement from FIG. 1; and

FIG. 7 is an additional detailed schematic view of a further development of the roll arrangement from FIG. 1.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

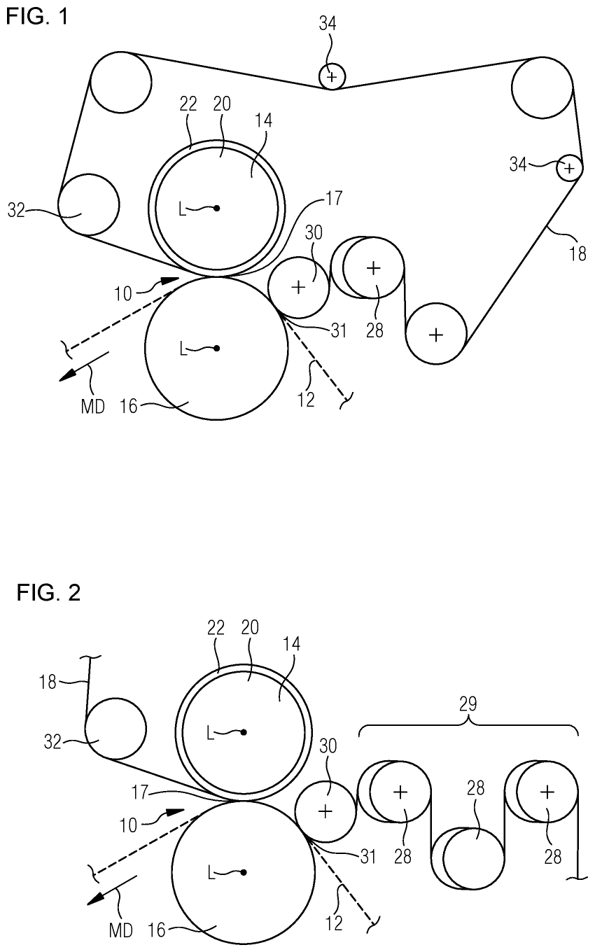

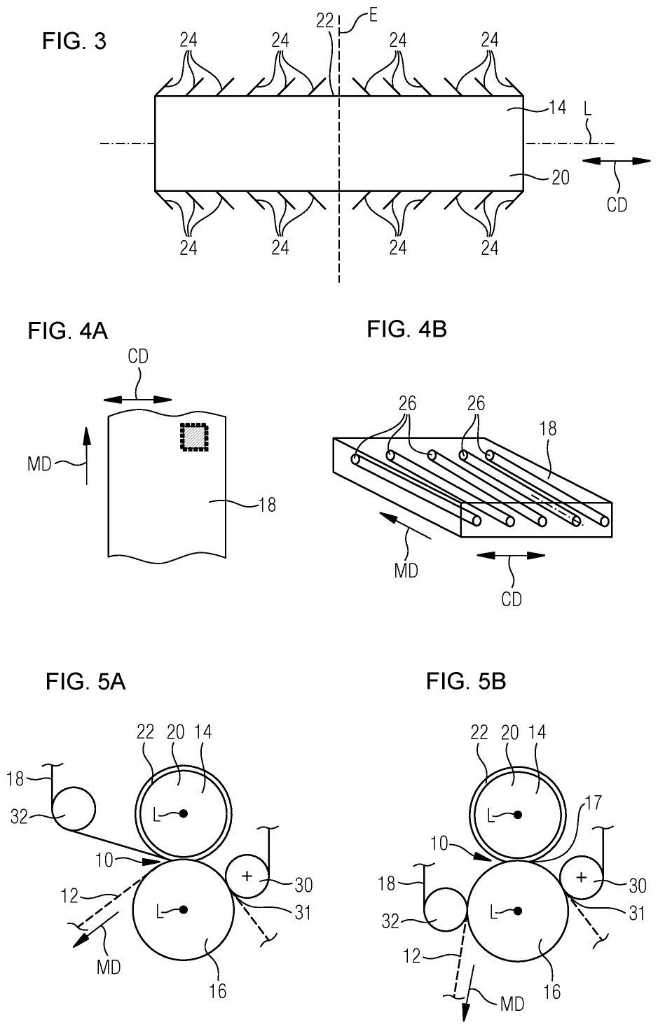

The drawings illustrate various aspects of a roll arrangement for the production of a compressed fibrous web. Specifically, FIG. 1 shows a roll arrangement, which represents a basic design form for the other embodiments shown in FIGS. 2, 5B, 6 and 7. FIGS. 3, 4A and 4A as well as 5A and 5B each show detailed aspects of the roll arrangement, which can be used in all of the embodiments shown.

In the following, a roll arrangement is explained in more detail with reference to the first embodiment shown in FIG. 1, with reference also being made to the remaining drawings.

The roll arrangement includes a compression press 10 for producing compression of a fibrous web 12 in a fibrous web plane in a direction transverse to the conveying direction of fibrous web 12. In the drawings, the conveying direction is indicated by arrow MD and the transverse direction by arrow CD (see in particular FIGS. 4A and 4B).

Compression press 10 includes a compression roll 14 and a mating roll 16 assigned to compression roll 14. Compression roll 14 and mating roll 16 together form a nip 17 (compression nip 17), through which an elastic tensioning belt 18 carrying fibrous web 12 is guided over compression roll 14 in order to cause a transverse compression of fibrous material web 12 in the fiber web plane in the direction transverse to conveying direction MD in compression nip 17. During the compression of fibrous web 12, tensioning belt 18 serves to evenly support fibrous web 12. The support of fibrous web 12 by tensioning belt 18 has the effect that only a small part of the web tension generated by the roll arrangement or the paper machine is transferred to fibrous web 12, since the remainder of the web tension is transferred to tensioning belt 18. As a result, the elongation at break and thus also the stretchability of fibrous web 12 can be increased.

Compression roll 14 has a rotationally symmetrical base body 20 that is rotatable around a longitudinal axis L and which has a shell surface 22, on which at least two elastically deformable and/or deflectable ring-shaped lamellae 24 are arranged, which extend radially away from shell surface 22 and which surround base body 20 in circumferential direction (FIG. 3). In the embodiment shown in FIG. 3, several lamellae 24 are inclined diagonally in pairs in a mirror-symmetrical manner in the direction of a central plane E of compression roll 14, forming an angle of inclination, wherein central plane E is aligned perpendicular relative to longitudinal axis L compreession roll 14.

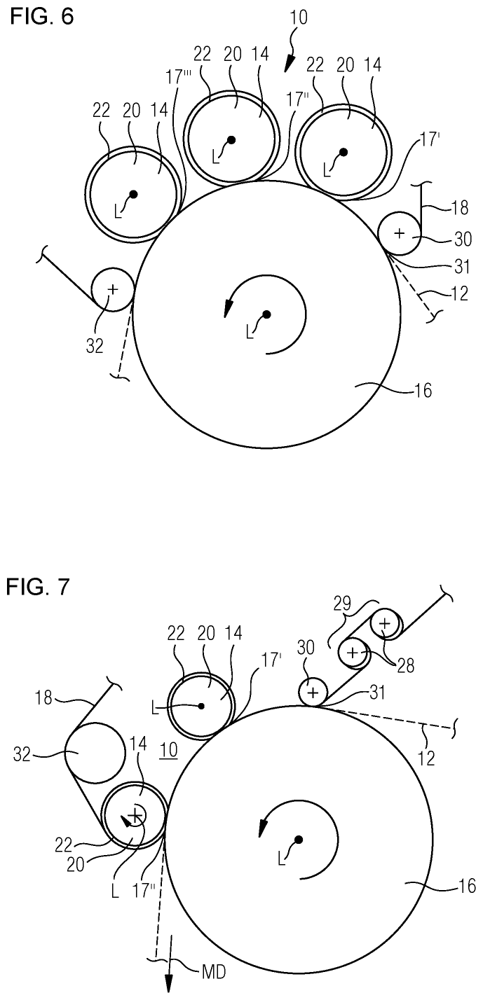

By applying pressure to lamellae 24 (generated by compression roll 16), lamellae 24 are deflected towards central plane E of compression roll 14. If the distance between compression roll 14 and mating roll 16 is adjustable, in particular if the distance between the respective longitudinal axis L of compression roll 14 and mating roll 16 is changable, the pressure acting on lamellae 24 can also be varied. The following applies: The smaller the distance between compression roll 14 and mating roll 16, the greater the deflection of lamellae 24 in commpression nip 17. Lamellae 24 are compressed in compression nip 17, that is, they are deflected in the direction of central plane E of compression roll 14, and subsequently move back to their original position. When compressed, lamellae 24—due to their design—generate inward-directed transverse forces, which directly compress tensioning belt 18 and indireclty fibrous web 12 conveyed by tensioning belt 18 while being fed to compression nip 17 in the transverse direction. For an even stronger compression of tensioning belt 18 or fibrous web 12 conveyed by tensioning belt 18, several commpression rolls 14 can be assigned to mating roll 16, each of which forms a compression nip 17 with mating roll 16 (FIGS. 6 and 7).

Tensioning belt 18 separates fibrous web 12 that is to be conveyed from compression roll 14, so that fibrous web 12 does not come into direct contact with lamellae 24 of compression roll 14. As a result, the shear forces occurring in compression nip 17 are not transferred directly to fibrous web 12, but to tensioning belt 18, wherein an undesirable puckering in fibrous web 12 or, in the worst case, damage to fibrous web 12, can be avoided.

So that tensioning belt 18 can transfer the movement of lamellae 24 in compression nip 17 to fibrous web 12, tensioning belt 18 is more elastic in transverse direction CD, in other words, in the direction transverse to conveying direction MD, than in conveying direction MD. This can be achieved by having at least one reinforcing way 26 extending in the direction of conveyance MD, whereby the elasticity of reinforcing way 26 is lower than the elasticity of tensioning belt 18. In the current design examples, reinforcing way 26 is represented by several reinforcing belts with a round cross-section, progressing essentially parallel to each other in MD direction (FIGS. 4A and 4B).

In order to provide sufficient support for fibrous web 12 and at the same time good stretchability of tensioning belt 18, tensioning belt 18 has a hardness of 20 to 65 Shore A and optionally from 25 to 60 Shore A at tensioning belt widths of less than or equal to 1 m. In the design examples, the hardness of tensioning belt 18 is between 30 and 55 Shore A for tensioning belt widths of less than or equal to 1 m. In contrast, tensioning belts having a width greater than or equal to 1 m, a hardness in a range of 30 to 65 Shore A and optionally from 35 to 60 Shore A is advantageous. In the design examples, the hardness of tensioning belt 18 is between 40 and 55 Shore A for tensioning belt widths greater than or equal to 1 m.

For a better transfer of the shear forces acting on fibrous web 12 in compression nip 17, tensioning belt 18 may have a structure on one side facing fibrous web 12 that is to be conveyed, which increases adhesion between tensioning belt 18 and fibrous web 12.

Mating roll 16 can have a smooth shell surface (optionally with a non-stick coating) to facilitate gliding of fibrous web 12 along the mating roll. In addition, or alternatively, for the same purpose, mating roll 16 may have a shell surface with openings through which compressed air or steam can be conducted, so that fibrous web 12 glides on an air cushion or a steam cushion along mating roll 16. The compressed air or steam can also escape from a porous shell surface of mating roll 16, with the same effect.

Before tensioning belt 18 can be compressed in transverse direction CD in compression nip 17 together with fibrous web 12, at least one spreader roll 28 is used to pre-tension tensioning belt 18 in the tensioning belt plane in transverse direction CD against the resilience of tensioning belt 18 before fibrous web 12 is received. This stretches the width of tensioning belt 18.

As can be seen from the embodiment shown in FIG. 2, several spreader rolls 28 can be combined to form a spreader roll arrangment 29 in order to allow an even greater width expansion of tensioning belt 18. In the embodiment shown in FIG. 2, spreader roll arrangement 29 specifically includes three spreader rolls 28. However, the number of spreader rolls 28 can also differ from three and include, for example, two, four or five spreader rolls 28. For example, two spreader rolls 28 may be sufficient for certain applications. It is also possible to use a spreader roll arrangement 29 with more than three spreader rolls 28, for example with four, five or more spreader rolls 28. The spreader rolls can have the same or different settings, such as arch height and/or wrap angle.

A feed roll 30 is provided between spreader roll 28 or last spreader roll 28 of spreader roll arrangement 29 which, together with mating roll 16 forms a nip 31 (feed nip 31). As shown in FIGS. 1 and 2, feed roll 30 is arranged immediately behind spreader roll 28 or last spreader roll 28 of a spreader roll arrangement 29 in order to lose as little width expansion as possible in tensioning belt 18. However, it may also be provided that—viewed in direction of conveyance—feed roll 30 is arranged at a distance from spreader roll 28 or last spreader roll 28 of a spreader roll arrangement 29, as long as a sufficient pre-stretching of tensioning belt 18 for the specific application can be maintained (FIG. 5).

Relaxation of tensioning belt 18 supports compression of fibrous web 12, so that in many cases a more uniform and/or greater transverse compression is produced than in applications where no prestressing of fibrous web 12 before compression nip 17 is provided.

Viewed in direction of conveyance, feed nip 31 between feed roll 30 and mating roll 16 is located upstream of compression nip 17. In the design examples shown, feed nip 31 is located at least 15° upstream of compression nip 17 (FIGS. 1, 2, 5A and 5B) or first compression nip 17′ (FIGS. 6 and 7). As a result, fibrous web 12 and tensioning belt 18 are already in contact with each other for a certain period of time before compression nip 17, which contributes to the stabilization of fibrous web 12 and thus ultimately to the achievement of a higher quality end product.

Feed nip 31 between feed roll 30 and mating roll 16 is also used for longitudinal compression of fibrous web 12 as described below.

Viewed in machine direction, the distance between feed roll 30 and mating roll 16 narrows toward the center of feed nip 31. Subsequently, the distance between feed roll 30 and mating roll 16 increases again. During conveyance of tensioning belt 18 and fibrous web 12 along feed nip 31, tensioning belt 18 and ultimately also fibrous web 12 conveyed by tensioning belt 18 are first accelerated due to the Venturi effect as a result of the narrowing and then decelerated due to the expansion behind the center of feed nip 31. As a result, tensioning belt 18 and fibrous web 12 that is to be conveyed are compressed in the direction of conveyance MD or respectively, longitudinally.

In order to ensure that tensioning belt 18 or fibrous web 12 that is to be conveyed is not accelerated too much in the narrowing of feed nip 31, it is advantageous if tensioning belt 18 consists of a material that is at least almost incompressible in a direction perpendicular to the plane of the tension belt and has a thickness of between 4 and 26 mm.

In the design examples shown, the thickness of the tensioning belt for tensioning belts having tensioning belt widths of less than or equal to 1 m is between 4 and 6 mm, whereas for tensioning belts having widths greater than or equal to 1 m, the thickness of the tensioning belt is between 4 and 26 mm.

In addition, a deflection roll 32 is provided, which is located downstream of compression press 10 in direction of conveyance MD of tensioning belt 18 and which guides tensioning belt 18 away from fibrous web 12 that is to be conveyed.

Deflection roll 32 can be arranged, for example, in a first position (FIG. 5A) or a second position (FIG. 5B). It is possible that deflection roll 32 is designed to be repositionable in such a way that conveyance of fibrous web 12 along a partial circumference of compression roll 14 and/or mating roll 16 can be selectively changed. It may also be possible to move the rolls between the two positions, for example to take account of different web speeds.

In the first position of deflection roll 32 shown in FIG. 5A, the roll arrangemet is designed for low conveying speeds, for example less than 25 m/min. As can be seen in FIG. 5A, tensioning belt 18 is guided in sections along compression roll 14 behind the compression nip 17 before it is guided away from compression roll 14 by way of deflection roll 32. As a result, lamellae 24 cannot immediately return to their undeflected original position after compression nip 17, which is advantageous at low conveying speeds, as the compression of fibrous web 12 generated in compression nip 17 is not disturbed again by a possible (partial) raising of lamellae 24.

In this embodiment, fibrous web 12 is separated from tensioning belt 18 immediately after compression nip 17.

In the second position of deflection roll 32 shown in FIG. 5B, the roll arrangement is especially suitable for higher conveying speeds, for example greater than 600 m/min. In the second position of deflection roll 32, tensioning belt 18 together with fibrous material web 12 is guided in sections along mating roll 16. This increases the dwell time of fibrous web 12 on tensioning belt 18, so that at higher conveying speeds there is sufficient time to transfer the transverse compression from tensioning belt 18 to fibrous web 12.

Moreover, roll arrangement 10 has a tensioning roller 34, which serves to adjust the pretension of tensioning belt 18 in the direction of conveyance (see FIG. 1). For example, tensioning roller 34 can be arranged on the inside of tensioning belt 18, so that tensioning belt 18 can be tensioned by relocating tensioning roller 34 outwards as required. Alternatively or in addition, tensioning roller 34 can be arranged on the outside of tensioning belt 18, so that tensioning belt 18 can be tensioned by relocating tension roller 34 inwards.

Below is an explanatory summary of the basic operating principle of the roll arrangement.

Before tensioning belt 18 is brought together with fibrous web 12, spreader roll 28 or respectively spreader rolls of the spreader roll arrangement are used to stretch tensioning belt 18 in the tensioning belt plane in the direction transverse to conveying direction MD, in other words, in its width.

Subsequently, tensioning belt 18 stretched in this way is passed over feed roll 30, and tensioning belt 18 and fibrous web 12 are brought together before feed nip 31 between feed roll 30 and mating roll 16. Due to the action of feed nip 31, fibrous web 12 and tensioning belt 18 are compressed in conveying direction MD due to the Venturi effect.

After feed nip 31, fibrous web 12 together with tensioning belt 18 is guided in sections along mating roll 16 to compression nip 17 of compression press 10. In this section, fibrous web 12 is reliably stabilized on both sides—namely by tensioning belt 18 on the one hand and mating roll 16 on the other. In compression press 10, tensioning belt 18 and fibrous web 12 are then compressed in a controlled manner in their planes in the direction transverse to conveying direction MD. Here, too, tensioning belt 18 has a stabilizing effect, in particular because it ensures a homogenization of the transverse forces acting upon fibrous web 12 in compression nip 17.

After tensioning belt 18 and fibrous web 12 have left compression nip 17 of compression press 10, tensionning belt 18 and fibrous web 12 are separated from each other in that tensioning belt 18 is separated from fibrous web 12 by way of deflection roll 32. Depending on the application, this separation can take place immediately after compression nip 17 or at a later point in time (see FIG. 5A or 5B).

As a result, a fibrous web 12 is produced by way of the roll arrangement, said web being evenly compressed in the fibrous web plane in longitudinal as well as in transverse direction.

Surprisingly, investigations have shown that the concept according to the present invention is suitable for web speeds in excess of 1000 m/min.

In addition, it should be mentioned that the tensioning belt can be made of rubber or can include rubber. Instead of rubber, another suitable elastic material can also be used. The tensioning belt can have a one-, two- or multi-layer structure. In principle, it is also conceivable that the tensioning belt has varying properties in the transverse direction.

### COMPONENT IDENTIFATION LISTING

10 Compression press
12 Fibrous web
14 Compression roll
16 Mating roll
17, 17′,
17″, 17″ Compression nip
18 Tensioning belt
20 Base body
22 Shell surface
24 Lamella
26 Reinforcing means
28 Spreader roll
29 Spreader roll arrangement
30 Feed roll
31 Feed nip
32 Deflection roll
34 Tensioning roller
MD Conveying/Machine direction
CD Transverse direction
L Longitudinal axis
E Center Plane

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A roll arrangement for producing a web of fibrous material which is compressed, the roll arrangement comprising:
a compression press, which includes at least one compression roll and a mating roll and is configured for compressing the web in a transverse direction which is transverse to a conveying direction of the web; and
a tensioning belt, which is elastic and is configured for supporting the web and for being guided through a first nip between the at least one compression roll and the mating roll and over the at least one compression roll.

2. The roll arrangement according to claim 1, wherein the tensioning belt is more elastic in the transverse direction than in the conveying direction.

3. The roll arrangement according to claim 1, wherein the tensioning belt includes at least one reinforcing device and a remaining portion, the at least one reinforcing device extending in the conveying direction and having a lower elasticity than the remaining portion of the tensioning belt.

4. The roll arrangement according to claim 3, wherein the at least one reinforcing device is at least one reinforcing belt.

5. The roll arrangement according to claim 1, wherein the tensioning belt (a) has a hardness of 20 to 65 Shore A at tensioning belt widths of less than or equal to 1 m, or (b) has a hardness of 30 to 65 Shore A at tensioning belt widths of of greater than or equal to 1 m.

6. The roll arrangement according to claim 1, wherein a thickness of the tensioning belt (a) for tensioning belts widths less than or equal to 1 m is between 4 and 6 mm, or (b) for tensioning belts widths greater than or equal to 1 m is between 4 and 26 mm.

7. The roll arrangement according to claim 1, wherein the tensioning belt includes structuring.

8. The roll arrangement according to claim 7, wherein the tensioning belt includes a side configured for facing the web, the side including the structuring.

9. The roll arrangement according to claim 1, further comprising at least one spreader roll or at least one spreader element, which is configured for pretensioning the tensioning belt in the transverse direction against a restoring force of the tensioning belt before the web is received.

10. The roll arrangement according to claim 9, wherein the at least one spreader element is a spreader brush or a spreader bar.

11. The roll arrangement according to claim 9, further comprising a feed roll which, together with the mating roll, forms a second nip which, viewed in a circumferential direction of the mating roll, is positioned upstream of the first nip formed by the at least one compression roll and the mating roll, viewed in the conveying direction.

12. The roll arrangement according to claim 11, wherein the feed roll is arranged between the at least one spreader roll and the mating roll.

13. The roll arrangement according to claim 12, wherein the fee roll is arranged immediately after the at least one spreader roll.

14. The roll arrangement according to claim 12, further comprising a deflection roll, which is located downstream of the compression press viewed in the conveying direction and which is configured for guiding the tensioning belt away from the web.

15. The roll arrangement according to claim 14, wherein the mating roll includes an angular section, and wherein the deflection roll is arranged such that the tensioning belt is configured for being guided over the angular section of the mating roll.

16. The roll arrangement according to claim 14, wherein the deflection roll is arranged such that the tensioning belt is configured for not being guided over the mating roll.

17. The roll arrangement according to claim 16, wherein the at least one compression roll includes an angular section, and wherein the deflection roll is arranged such that the tensioning belt is configured for being guided over the angular section of the at least one compression roll.

18. The roll arrangement according to claim 14, wherein the deflection roll is configured for being repositionable such that a conveyance of the web along a partial circumference of at least one of the at least one compression roll and the mating roll is selectively changeable.

19. The roll arrangement according to claim 14, further comprising a tensioning roller which is configured for being repositioned so as to adjust a pretension of the tensioning belt in the conveying direction.

20. The roll arrangement according to claim 1, wherein the mating roll includes a smooth shell surface or a porous shell surface that includes a plurality of openings.

21. The roll arrangement according to claim 1, wherein the at least one compression roll includes a base body and a plurality of lamellae which are ring-shaped and at least one of elastically deformable and elastically deflectable, wherein the base body is rotationally symmetrical, is configured for being rotated around a longitudinal axis of the at least one compression roll, and includes a shell surface, on which the plurality of lamellae are arranged, the plurality of lamellae extending radially away from the shell surface and surrounding the base body in a circumferential direction of the base body.

22. The roll arrangement acording to claim 21, wherein the plurality of lamellae are inclined diagonally in a respective pair in a mirror-symmetrical manner in a direction of a central plane of the at least one compression roll, thereby forming an angle of inclination, wherein the central plane is aligned perpendicular relative to the longitudinal axis of the at least one compression roll.

23. The roll arrangement according to claim 1, wherein the roll arrangement is configured such that a distance between the at least one compression roll and the mating roll is adjustable.

24. The roll arrangement according to claim 1, further comprising a plurality of the at least one compression roll and a plurality of the first nip, each of the plurality of the at least one compression roll being assigned to the mating roll and forming a respective one of the plurality of the first nip with the mating roll.

25. A method for producing a web of fibrous material which is compressed, the method comprising the steps of:
using a roll arrangement to produce the web, the roll arrangement including:
a compression press, which includes at least one compression roll and a mating roll and is configured for compressing the web in a transverse direction which is transverse to a conveying direction of the web; and
a tensioning belt, which is elastic and is configured for supporting the web and for being guided through a first nip between the at least one compression roll and the mating roll and over the at least one compression roll;
merging the web with the tensioning belt, which receives the web to convey the web in the conveying direction;
conveying the tensioning belt together with the web to the compression press, which is configured for producing the web in the transverse direction which is transverse to the conveying direction of the web in a web plane; and
guiding the tensioning belt together with the web through the first nip formed between the at least one compression roll and the mating roll and over the at least one compression roll so as to compress the web transversely to the conveying direction in the web plane.
